(19) United States
(12) Patent Application Publication
(10) Pub. No.: US 2011/0246474 A1
(43) Pub. Date: Oct. 6, 2011

(54) DATA MANAGEMENT APPARATUS, DATA MANAGEMENT METHOD, AND DATA MANAGEMENT PROGRAM

(76) Inventors: Koichi Abe, Hyogo (JP); Shogo Tsubouchi, Hyogo (JP); Shinichi Yasuda, Hyogo (JP)

(21) Appl. No.: 12/998,880

(22) PCT Filed: Aug. 5, 2009
(86) PCT No.: PCT/JP2009/003750

§ 371 Date: Jun. 13, 2011

(30) Foreign Application Priority Data
Dec. 17, 2008 (JP) 2008-321259

(51) Int. Cl. G06F 17/30

(52) U.S. Cl. 707/741; 707/E17.123

(57) ABSTRACT

[Problems to be Solved by the Invention] It is an object of the present invention to provide a data management apparatus capable of efficiently managing various data that is transmitted and received via a network, by automatically and adequately generating an ID with which the identity of pieces of data can be verified and associating the ID with the pieces of data, even if specifying information such as a marking assigned to the piece of data is modified by a completely independent server.

[Means for Solving the Problems] A data management apparatus includes: an identification information storing unit that stores a plurality of pieces of identification information that are associated with a plurality of groups, respectively; a specifying information obtaining unit that obtains a piece of specifying information assigned to a piece of data; a collating unit that collates the piece of specifying information and each of the plurality of pieces of identification information, and judges whether the piece of specifying information matches any one of the plurality of pieces of identification information; and an assigning unit that assigns the piece of data to a group associated with the piece of identification information judged by the collating unit to be matched, from among the plurality of groups.

### TECHNICAL FIELD

The present invention relates to a data management apparatus, a data management method, and a data management program.

### BACKGROUND ART

A number of cases in which a plurality of servers that store video data and audio data are operated in cooperation have been increasing. For example, in a live sport relay broadcast in a stadium such as a baseball stadium, video data and audio data input from a plurality of cameras are saved in separate servers, and a plurality of operators work in cooperation using the video data and audio data. In this case, management of data that is transmitted and received is especially important, and there may be a case where a problem such as by mixing up of pieces of data even in a single server may cause irrecoverable damage. In view of such a problem, there is known a technique in which a unique value, i.e. specifying information such as a hash value or a Universally Unique Identifier (UUID), for example, is assigned to each piece of data to specify the piece of data (for example, see Japanese Patent Application Publication No. H11-215120).

Alternatively, in a case in which the data that is transmitted and received is video data or audio data, an operator may extract a plurality of clips out of the recorded video data or audio data and respectively assign markings thereto as specifying information. A graphic symbol such as an icon previously stored in a server can be used as markings to be assigned, instead of names and thumbnails. Some of such graphic symbols can be arbitrarily modified or newly created even while the size of the data is fixed.

### CITATION LIST

### Patent Literature

PTL 1: Japanese Unexamined Patent Application Publication No. H11-215120

### SUMMARY OF INVENTION

### Technical Problem

Due to the servers being connected to each other via a network, each operator can have access to information on all of the servers via a terminal that the operator uses, and can collect pieces of data to which an identical graphic symbol is assigned out of all of the data on the network. However, since these servers are usually in the possession of different organizations or individuals, and are often separately managed and used, pieces of data to which an identical graphic symbol is assigned are often registered with different IDs, and pieces of data that are registered with different IDs can be assigned with an identical graphic symbol. As a result, cumbersome handling is necessary in that the operator who operates each server separately identifies graphic symbols one by one, and determines whether the pieces of data are identical or not.

Conducting a binary comparison of images of graphic symbols individually to identify the graphic symbols separately has a cost that is too burdensome. Furthermore, although it is conceivable to devise a method of ID generation in order to solve the inconsistency of IDs, this requires the IDs to be reversibly compressed data in order to make the IDs perfectly identifiable, which increases the cost in comparison.

As a different solution, it is possible to provide a data server for centrally managing the IDs of the data, and only use the graphic symbols registered in the data server as the markings. However, this can cause a considerable problem when the data server goes down due to a failure, and can incur an additionally cost. While it is also possible to match the graphic symbols and the IDs in a stage preparation for cooperative use of the data, this can be cumbersome because the matching is carried out manually by the operator.

The present invention was conceived to solve the existing problems mentioned above, and has an object to provide a data management apparatus, data management method, and data management program, capable of efficiently managing various data that is transmitted and received via a network, by automatically and adequately generating an ID with which the identity of pieces of data can be verified and associating the ID with the pieces of data, even if specifying information such as a marking assigned to the piece of data is edited by a completely independent server.

### Solution to Problem

In accordance with a first aspect of the present invention, there is provided a data management apparatus that manages data transmitted and received between computers, the data management apparatus comprising: a specifying information obtaining unit that obtains a piece of specifying information assigned to a piece of data; an identification information storing unit that stores a plurality of pieces of identification information that are associated with a plurality of groups, respectively; a collating unit that collates the piece of specifying information and the plurality of pieces of identification information, and specifies a corresponding one of the pieces of identification information; and an assigning unit that assigns the piece of data to a group associated with the piece of identification information specified by the collating unit, in which the piece of specifying information and the plurality of pieces of identification information are generated to respectively include pieces of unmodifiable basic information that correspond to the plurality of groups, and the collating unit specifies the corresponding piece of identification information based on the basic information included in the piece of specifying information.

With this configuration, the data management apparatus according to the present invention is provided with: a specifying information obtaining unit that obtains a piece of specifying information assigned to a piece of data; an identification information storing unit that stores a plurality of pieces of identification information that are associated with a plurality of groups, respectively; a collating unit that collates the piece of specifying information and the plurality of pieces of identification information, and specifies a corresponding one of the pieces of identification information; and an assigning unit that assigns the piece of data to a group associated with the piece of identification information specified by the collating unit, in which the piece of specifying information and the plurality of pieces of identification information are generated to respectively include pieces of unmodifiable basic information that correspond to the plurality of groups, and the collating unit specifies the corresponding piece of identification information based on the basic information included in the piece of specifying information. Accordingly, it is possible to assign the piece of data to a group to which the piece of data can suitably belong based on the unmodifiable basic information included in the specifying information, even if the specifying information such as a marking assigned to the piece of data is assigned or edited by a server that is independently managed. Therefore, it is possible to efficiently manage various data that is transmitted and received via a network, by automatically and adequately generating an ID with which the identity of pieces of data can be verified, and associating the ID with the pieces of data based on the assignment, even if the specifying information such as the marking assigned to the piece of data is altered by a completely independent server.

Furthermore, in the data management apparatus according to the present invention, the piece of specifying information can be generated by adding a piece of additional information as a modification target to the piece of basic information. The plurality of pieces of identification information is generated by adding the piece of additional information, according to a predetermined technique, to one of the plurality of pieces of unmodifiable basic information that correspond to the plurality of groups on a one-to-one basis, and the collating unit collates the piece of specifying information and the plurality of pieces of identification information to judge whether or not the pieces of information match, after modifying the piece of specifying information so as to make the piece of additional information included in the piece of specifying information in the same condition as the pieces of additional information added to each of the plurality of pieces of identification information according to the predetermined technique.

According to the above configuration, in the data management apparatus according to the present invention, even if the piece of specifying information is generated by adding the piece of additional information as the modification target to the piece of basic information, the plurality of pieces of identification information is generated by adding the piece of additional information, according to a predetermined technique, to one of the plurality of pieces of unmodifiable basic information that correspond to the plurality of groups on a one-to-one basis, and the collating unit collates the piece of specifying information and the plurality of pieces of identification information to judge whether or not the pieces of information match, after modifying the piece of specifying information so as to make the piece of additional information included in the piece of specifying information in the same condition as the pieces of additional information included in each of the plurality of pieces of identification information according to the predetermined technique. Therefore, no matter what kind of modification is made to a piece of specifying information such as a marking added to the data by such as an independently managed server, the piece of specifying information is collated with the pieces of identification information to judge whether or not the pieces of information match, after modifying a portion corresponding to the piece of additional information included in the piece of specifying information to be in the same condition as a portion corresponding to the pieces of additional information included in the plurality of pieces of identification information. Therefore, it is possible to adequately assign the piece of data to the group to which the piece of data can belong based on the piece of basic information.

In addition, in the data management apparatus according to the present invention, the piece of specifying information can represent a graphic symbol, or the pieces of basic information can each represent a shape of a graphic symbol, and the piece of additional information represents a color of the graphic symbol. According to the above configuration, in the data management apparatus according to the present invention, it is possible to realize management of data assigned with a piece of specifying information using markings that are commercially available, for example. However, the present invention is not limited to such a configuration, and the basic information can be any information as long as it represents a portion of the specifying information that is hardly modified, and the additional information can be determined according to an implementation as long as it is included in the specifying information. Furthermore, the specifying information is not limited to the graphic symbols, and as long as it includes the basic information that is not modified very often if a user edits the information as a portion of the specifying information, other information such as values, portions of audio data, or such can be used as the specifying information, in addition to the markings and graphic symbols.

In addition, the data management apparatus according to the present invention can be such that each of the plurality of pieces of identification information includes a first piece of collating information and a second piece of collating information, the collating unit collates the piece of specifying information and the first piece of collating information included in each of the plurality of pieces of identification information, when it is judged that the piece of specifying information is matched with the first piece of collating information of one of the plurality of pieces of identification information, the piece of specifying information is collated with the second piece of collating information of the one piece of identification information that has been judged to be matched with the piece of specifying information, and when it is determined that the piece of specifying information is matched with the second piece of collating information of the one piece of identification information, the assigning unit assigns the piece of data to one of the groups that is associated with the one piece of identification information.

It is assumed that, when a piece of specifying information is collated with a piece of identification information extracted from the data, a binary comparison of each piece of information by the binary value can be conducted separately. However, this makes a cost too burdensome. Accordingly, the specifying information and the identification information can be converted respectively into pieces of simple information, for example, the first pieces of collating information, and pieces of more complex information, for example, the second pieces of collating information, and then compared. Then, only when the specifying information is determined to be matched with the first piece of collating information, the specifying information can be collated with a piece of precise information, for example, the second piece of collating information, and when the specifying information is determined to be matched with the second piece of collating information, the data can be assigned to the group corresponding to the identification information. With this, a cost and time involved in the comparison and collation can be reduced to a large extent.

Furthermore, in the data management apparatus according to the present invention, for example, the plurality of first pieces of collating information can each include a hash value of the plurality of pieces of identification information, or the plurality of second pieces of collating information can each include a binary value of the plurality of pieces of identification information. According to the present invention, the first piece of collating information and the second piece of collating information can be any values other than the binary values or hash values, as long as the second piece of collating information is more precise than the first piece of collating information and it is considered to be suitable considering an application and an amount of the managed data. According to the above configuration, in the data management apparatus according to the present invention, the cost and time involved in a comparison and collation can be reduced to a large extent.

In addition, the data management apparatus according to the present invention can be such that the identification information storing unit stores a plurality of pieces of unique information that are associated with the plurality of groups on a one-to-one basis, and when the assigning unit assigns the piece of data to one of the groups, the identification information storing unit stores the piece of unique information associated with the one group as the unique information of the piece of data.

According to the above configuration, the data management apparatus according to the present invention can automatically negotiate among servers, especially when a new server is connected to a network, and register pieces of unique information that are associated with the data, for example, IDs, without overlapping, even without a server of an upper level that manages negotiation among the servers.

Furthermore, the data management apparatus according to the present invention can be such that when the identification information storing unit stores the piece of unique information associated with the one group as the unique information of the piece of data, if a piece of unique information different from the piece of unique information associated with the one group is already stored in the identification information storing unit as the unique information of the piece of data, the identification information storing unit compares the piece of unique information associated with the one group with the unique information of the piece of data that is already stored in the identification information storing unit, and replaces one of the pieces of unique information associated with the one group and the unique information of the piece of data with the other according to a predetermined rule.

According to the above configuration, in the data management apparatus according to the present invention, even when different pieces of unique information, for example, IDs, have already been assigned to the data among the servers, and even when there is a possibility that an overlapping piece of unique information, for example, an ID can be assigned, it is possible to adjust the pieces of unique information, for example, the IDs according to the predetermined rule, without a server of an upper level that manages negotiation among the servers. As the predetermined rule, for example, it is possible to select one having a greater value; however, the present invention is not limited to such an example, and it is apparent to a person having ordinary skill in the art that various rules can be applied as long as the pieces of unique information, for example, IDs, can be adjusted without overlapping.

In accordance with a second aspect of the present invention, there is provided a data management method that manages data transmitted and received between computers, the data management method comprising: a specifying information obtaining step of obtaining a piece of specifying information assigned to a piece of data; an identification information storing step of storing a plurality of pieces of identification information that are associated with a plurality of groups, respectively; a collating step of collating the piece of specifying information and the plurality of pieces of identification information, and specifying a corresponding one of the pieces of identification information; and an assigning step of assigning the piece of data to a group associated with the piece of identification information specified in the collating step, wherein the piece of specifying information and the plurality of pieces of identification information are generated to respectively include pieces of unmodifiable basic information that correspond to the plurality of groups, and wherein the collating step includes a step of specifying the corresponding piece of identification information based on the basic information included in the piece of specifying information.

With this configuration, the data management method according to the present invention can assign the piece of data to a group to which the piece of data can suitably belong based on the unmodifiable basic information included in the specifying information, even if the specifying information such as a marking assigned to the piece of data is assigned or edited by a server that is independently managed, since the data management method is provided with: a specifying information obtaining step of obtaining a piece of specifying information assigned to a piece of data; an identification information storing step of storing a plurality of pieces of identification information that are associated with a plurality of groups, respectively; a collating step of collating the piece of specifying information and the plurality of pieces of identification information, and specifying a corresponding one of the pieces of identification information; and an assigning step of assigning the piece of data to a group associated with the piece of identification information specified in the collating step, wherein the piece of specifying information and the plurality of pieces of identification information are generated to respectively include pieces of unmodifiable basic information that correspond to the plurality of groups, and wherein the collating step includes a step of specifying the corresponding piece of identification information based on the basic information included in the piece of specifying information. Therefore, it is possible to efficiently manage various data that is transmitted and received via a network, by automatically and adequately generating an ID with which the identity of pieces of data can be verified, and associating the ID with the pieces of data based on the assignment, even if the specifying information such as the marking assigned to the piece of data is altered by a completely independent server.

In accordance with a third aspect of the present invention, there is provided a data management program for managing data transmitted and received between computers, the data management program being executable by a computer to carry out: a specifying information obtaining step of obtaining a piece of specifying information assigned to a piece of data; an identification information storing step of storing a plurality of pieces of identification information that are associated with a plurality of groups, respectively; a collating step of collating the piece of specifying information and the plurality of pieces of identification information, and specifying a corresponding one of the pieces of identification information; and an assigning step of assigning the piece of data to a group associated with the piece of identification information specified in the collating step, wherein the piece of specifying information and the plurality of pieces of identification information are generated to respectively include pieces of unmodifiable basic information that correspond to the plurality of groups, and wherein the collating step includes a step of specifying the corresponding piece of identification information based on the basic information included in the piece of specifying information.

With this configuration, the data management program according to the present invention can have a computer carry out processing of assigning the piece of data to a group to which the piece of data can suitably belong based on the unmodifiable basic information included in the specifying information, even if the specifying information such as a marking assigned to the piece of data is assigned or edited by a server that is independently managed. Therefore, it is possible to efficiently manage various data that is transmitted and received via a network, by automatically and adequately generating an ID with which the identity of pieces of data can be verified, and associating the ID with the pieces of data based on the assignment, even if the specifying information such as the marking assigned to the piece of data is altered by a completely independent server.

### Advantageous Effects of Invention

According to the present invention, it is possible to provide a data management apparatus, data management method, and data management program, capable of efficiently managing various data that is transmitted and received via a network, by automatically and suitably generating an ID with which the identity of a plurality of pieces of data can be verified and associating the ID with the pieces of data, even if specifying information such as a marking assigned to a piece of data is edited by a completely independent server.

### BRIEF DESCRIPTION OF DRAWINGS

FIG. 1 is a schematic diagram illustrating an information processing system that includes a data management apparatus according to one embodiment of the present invention;

FIG. 2 is a diagram showing a state in which the data management apparatus of FIG. 1 is carrying out negotiation and an ID is assigned to each piece of data;

FIG. 3 is a circuit block diagram of an image server including the data management apparatus of FIG. 1;

FIG. 4 is a diagram showing one example of specifying information assigned to the piece of data;

FIG. 5 is a diagram showing one example of an editing screen for editing the specifying information;

FIG. 6 is a functional configuration diagram of the data management apparatus of FIG. 1;

FIG. 7 is a flowchart illustrating one example of a data management method carried out by the data management apparatus of FIG. 1;

FIG. 8 is a diagram illustrating a relationship between basic specifying information and modified specifying information;

FIG. 9 is a table showing a relationship between the specifying information, the identification information, and a unique information ID of a group to be assigned;

FIG. 10 is a flowchart illustrating one example of a collating process carried out by the data management apparatus of FIG. 1;

FIG. 11 is a diagram schematically illustrating a marking assigned to the piece of data;

FIG. 12 is a diagram showing a relationship between the marking, the unique information ID, and a hash value;

FIG. 13 is a diagram showing one example of a method of generating identification information;

FIG. 14 is a flowchart illustrating one example of assignment processing carried out by the data management apparatus of FIG. 1; and

FIG. 15 is a diagram illustrating details of assignment processing of the unique information ID without overlapping.

### DESCRIPTION OF EMBODIMENTS

Specific embodiments according to the present invention are described in detail with reference to the drawings.

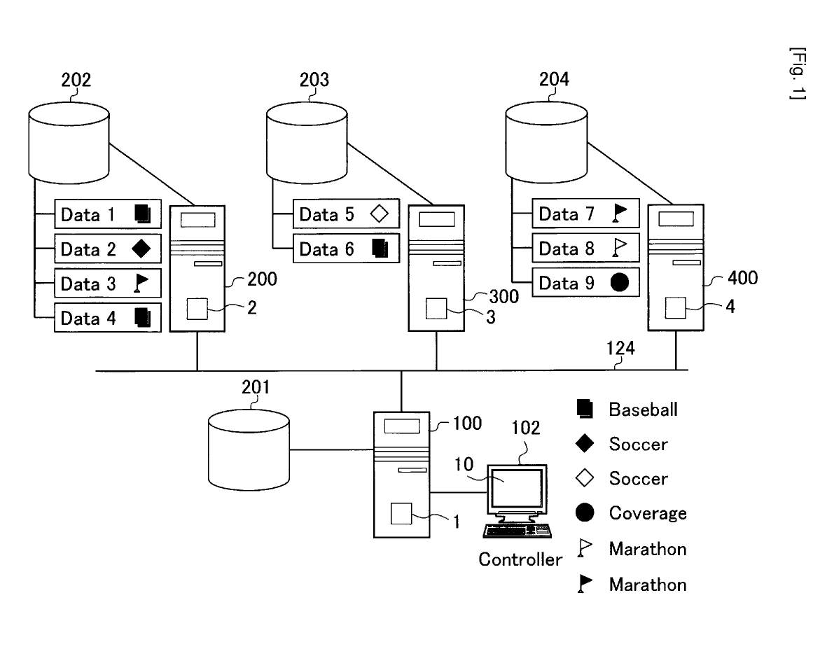

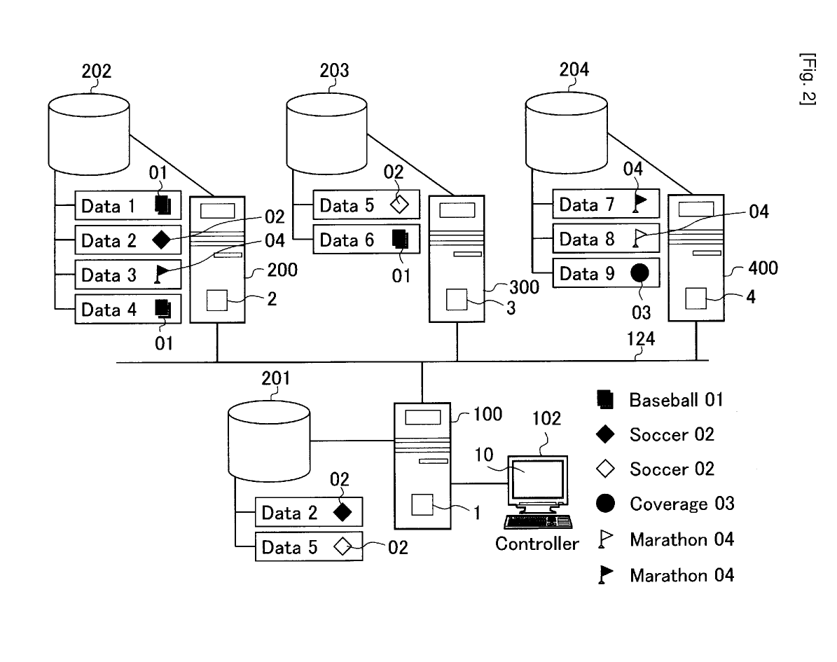

FIG. 1 and FIG. 2 are schematic diagrams illustrating an information processing system including a data management apparatus according to one embodiment of the present invention. This information processing apparatus may correspond to, for example, a moving image editing and storing system, and the data management apparatus may form a part of an image server or a moving image editing apparatus. As shown in FIG. 1, the information processing system includes a controller 102 and image servers 100 to 400. The controller 102 and the image server 100 constitute a moving image editing apparatus. The image server 100 includes a data management apparatus 1 and a data storing unit 201, the image server 200 includes a data management apparatus 2 and a data storing unit 202 having stored therein pieces of data 1 to 4, the image server 300 includes a data management apparatus 3 and a data storing unit 203 having stored therein pieces of data 5, 6, the image server 400 includes a data management apparatus 4 and a data storing unit 204 having stored therein pieces of data 7 to 9.

The pieces of data 1, 4, 6 are respectively assigned with graphic symbols that are identical as markings. The pieces of data 2 and 5 are respectively assigned with graphic symbols that are different in color (the colors are either white or black in FIG. 1 and FIG. 2), but identical in shape as markings. The pieces of data 3, 7, and 8 are respectively assigned with graphic symbols that are different in color, but identical in shape as markings. The graphic symbols that are identical in shape represent the corresponding pieces of data relating to information that belong to the same group or category, and in an example of FIG. 1, as shown in right bottom, each shape represents that the corresponding information belongs to a category of, for example, live relay broadcasts of baseball, live relay broadcasts of soccer, news shows, or live relay broadcasts of marathons. The data management apparatuses 1 to 4 respectively of the image servers 100 to 400 always transmit and receive information, and mutually identify the pieces of data stored in each image server. The data management apparatuses 1 to 4 are configured to share the pieces of data by assigning an adequate ID to each piece of data or updating the ID to an adequate one.

FIG. 2 is a diagram showing a state after the data management apparatuses 1 to 4 of the image servers 100 to 400 carry out negotiation to mutually transmit and receive information, mutually identify the pieces of data stored in each image server by conducting a comparison between the graphic symbols and colors in the background, and assign an adequate ID to each piece of data or updating the ID to an adequate one.

Groups are respectively assigned to the pieces of data 1 to 9 stored in the data storing units 202 to 204 of the image servers 200 to 400 so that the pieces of data represented by an identical graphic symbol belong to the same group, and each piece of data is assigned with any of the ID numbers 01 to 04. In an example of FIG. 2, as shown at the bottom right, the ID number 01 represents that the corresponding information belongs to the category of live relay broadcasts of baseball, the ID number 02 represents that the corresponding information belongs to the category of live relay broadcasts of soccer, the ID number 03 represents that the corresponding information belongs to the category of news shows, the ID number 04 represents that the corresponding information belongs to the category of marathons, and such. By classifying the pieces of data in this manner and, for example, showing the category of a content of the piece of data, it becomes known to an operator that, when the operator edits a moving picture relating to soccer, for example, the pieces of data having the ID number 02 should be retrieved from the image servers 100 to 400 by manipulating the controller 102. As a result, it is possible to reduce the labor involved in retrieval of the pieces of data by the operator to a large extent.

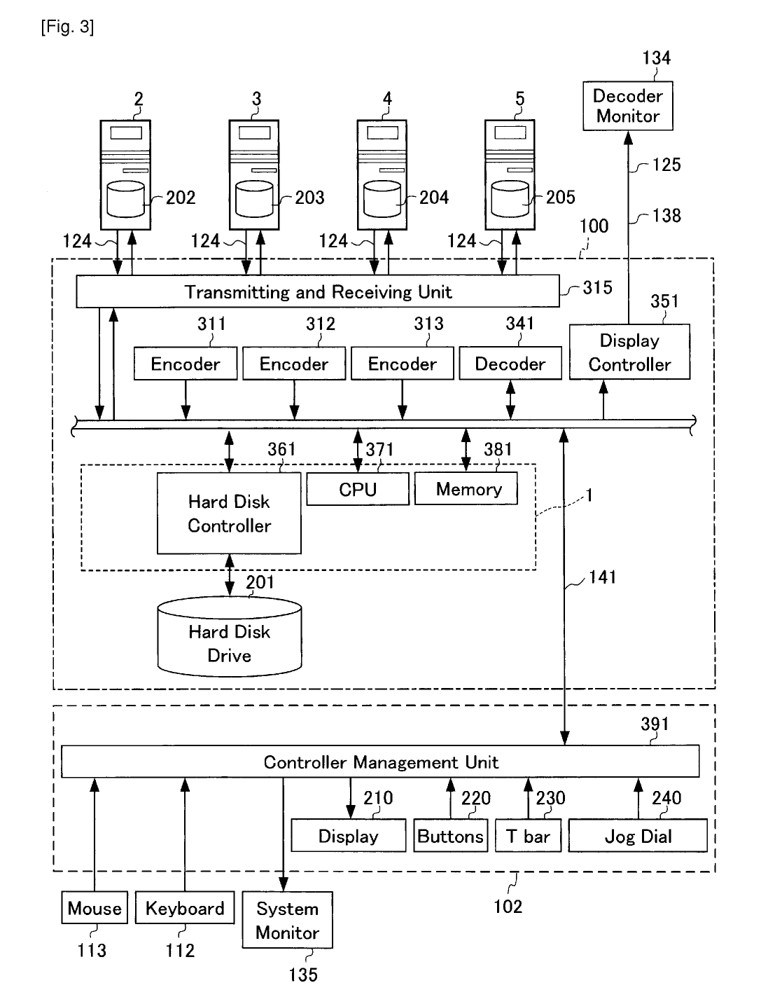

FIG. 3 is a circuit block diagram of the image server 100 including the data management apparatus 1 according to the present embodiment of the invention. As shown in FIG. 3, the data control apparatus 1 is provided with a CPU 371, a hard disk controller 361, a memory 381, and the like.

The image server 100, the controller 102, and other components are connected using, for example, a LAN (Local Area Network) 141 to connect the image server 100 and the controller 102, a cable 124 to connect the image server 100 and other image servers 200 to 400, a cable 125 to connect the image server 100 and the decoder monitor 134, a cable to connect the controller 102 and the system monitor 135, and so on. However, the method of connection is not limited thereto, and may include any other wired or wireless connection methods as appropriate. It should be noted that the image server 100 may also be configured as a single unit integrating the controller 102, although they are described as separate units.

The other servers 200 to 400 respectively include data storing units 202, 203, 204, each constituted by, for example a hard disk for storing therein data. The image server 100 transmits and receives data with the image servers 200 to 400 through a transmitting and receiving unit 315. The image server 100 stores various specifying information of each of the data received from the image servers 200 to 400 through the transmitting and receiving unit 315 such as during the negotiation in the memory 381. The memory 381 constitutes an identification information storing unit, which is described below. Further, the image server 100 may encode, for example, a moving image signal received from the image servers 200 to 400 through the transmission and receiving unit 315 into an encoded moving image signal, and stores the encoded moving image signal in the hard disk drive 201 as moving image data. Further, the image server 100 may decode the moving image data into a moving image signal, and send the moving image signal to the decoder monitor 134. The decoder monitor 134 may display moving images based on the moving image signal received from the image server 100. The term “moving image” herein used includes a “still image”, as well. The decoder 341 reads out encoded moving image data from the hard disk drive 201, decodes the encoded moving image data and sends the moving image signal thus decoded to the display controller 351 or the like.

The controller 102 sends and receives signals via the image server 100 and the LAN 141, and displays a user interface on the display 210, based on the signal sent from the image server 106 and the user input. Furthermore, the controller 102 converts user's requests that has been input by the keyboard 112, by the mouse 113 or by the controller 102 itself to a signal, and sends the signal to the image server 106. In addition, the controller 102 sends the signal for displaying the user interface to the system monitor 135 via the cable.

The image servers 200 to 400 send moving image signals stored in respective data storing units 202, 203, 204 to the image server 100 through the cable 124 as occasion demands. The data storing unit 202 of the image server 200 stores pieces of data 1 to 4, the data storing unit 203 of the image server 300 stores pieces of data 5, 6, and the data storing unit 204 of the image server 400 stores pieces of data 7 to 9.

The hard disk drive (HDD) 201 constitutes the data storing unit for storing programs that are to be executed by the CPU 371, and various data such as encoded moving image data and audio data, unencoded moving image data and audio data, or the like, sent from the other image servers 200 to 400. Furthermore, the hard disk drive 201 may be provided either within the image server 100, outside of the image server 100, or both within the image server 100 and outside of the image server 100. Moreover, for explanatory purposes, the identification information storing unit is described as the memory 381 in the present embodiment; however, the present invention is not limited thereto. So long as it is capable of storing identification information with respect to data, any memory device other than the memory 381, for example, the hard disk drive 201, a tape drive, an optical disk drive, a semiconductor memory, or any combination thereof, may be used. The CPU 371 controls the hard disk controller 361 to reads out and writes in various data stored in the hard disk drive 201. The hard disk controller 361 constitutes a specifying information obtaining unit, which is described below.

The CPU 371 reads out programs stored in the memory 381, and executes each type of processing in accordance with the programs contained therein. The programs executed by the CPU 371 include, for example, applications for editing or replaying moving image data, a data management program for executing a data management method, an OS (Operating System) for controlling each of the devices connected to the bus, and so on. The CPU 371 constitutes a collating unit and an assigning unit.

The memory 381 stores programs that have been read out from the hard disk drive 201. The programs include, for example, applications for editing or replaying moving image data in response to input and output from the controller 102, a program for executing a data management method according to the present invention, an OS for controlling each of the devices connected to the bus, and so on. Furthermore, the memory 381 may store identification information of the moving image data that the image server 100 transmits and receives with the other image servers 200 to 400, and the moving image signals and data from the devices connected to the bus.

The decoder monitor 134 is connected to the display controller 351, and displays moving images based on the moving image signal, such as a VGA signal, sent from the display controller 351. The decoder monitor 134 is used when the content of the moving image signal is to be monitored; however, it is not necessarily required in the configuration of the data management apparatus 1.

Furthermore, the controller 102 is provided with a controller controlling portion 391, a built-in display 210, button groups 220, a T-bar 230, and a jog dial 240.

The controller controlling portion 391 is provided with a CPU and memory (not shown). The controller controlling portion 391 sends to and receives from the image server 106 signals, sends a signal for displaying the user interface to the display 210 and the system monitor 135, and sends request commands and input data received as input from the button group 220, the T-bar 230, the jog dial 240, the keyboard 112, and the mouse 113 to the image server 100. The specifying information of the data including the marking stored in the image servers 200 to 400 is displayed by the display 210 or by the decoder monitor 134.

The constitutions and operations of the other data management apparatus 2 to 4 (shown in FIGS. 1 and 2) and the image servers 200 to 400 are substantially the same as those of the data management apparatus 1 and the image server 100. Therefore, the description hereinafter is focused on the data management apparatus 1 and the image server 100 and the detailed descriptions of the other data management apparatus 2 to 4 (shown in FIGS. 1 and 2) and the image servers 200 to 400 are omitted.

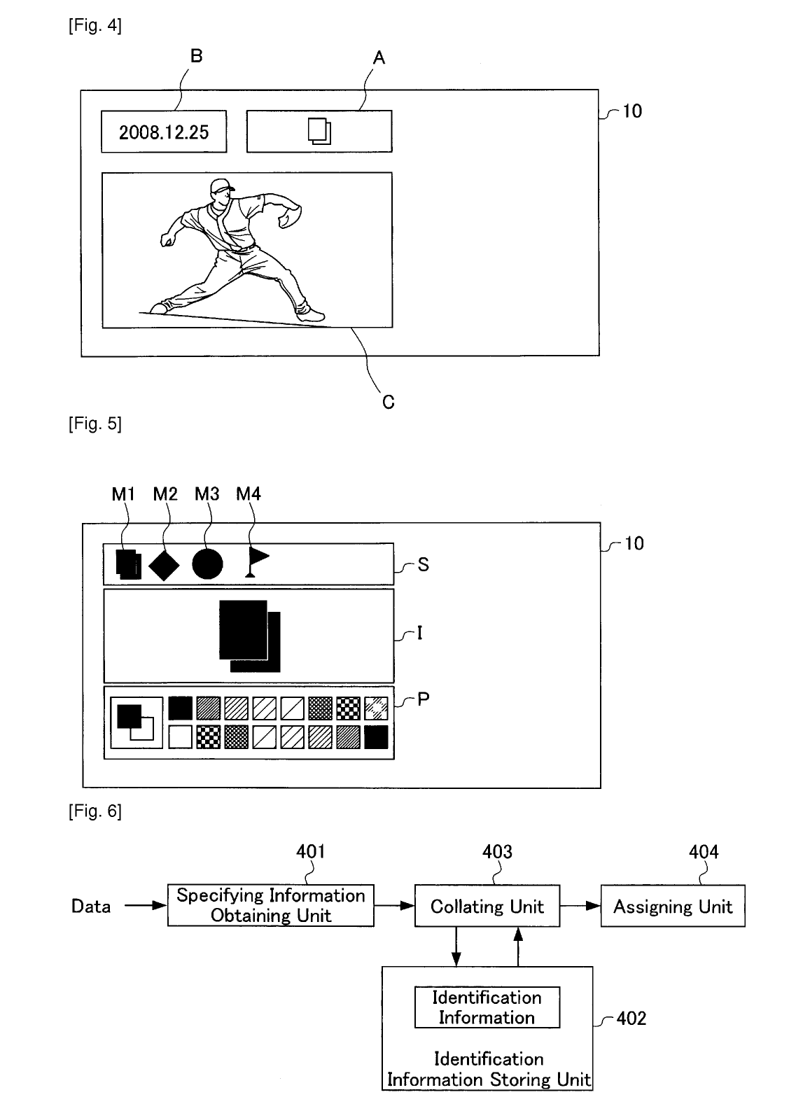

FIG. 4 shows one example of a piece of specifying information assigned to a piece of data displayed on a screen 10 of the display 210. Referring to FIG. 4, as the piece of specifying information of the piece of data, a marker graphic symbol (icon) A assigned to the piece of data, a date B at which the piece of data is created, and a thumbnail C of the piece of data are displayed. While the date B at which the piece of data is created and the thumbnail C of the piece of data are generated automatically for each piece of data, the marker graphic symbol (icon) A is added by an operator who has taken or edited the piece of data.

FIG. 5 shows one example of an edit screen of the marking A displayed as the specifying information on the screen 10 of the display 210. Referring to FIG. 5, four marker graphic symbols (icons) including M1 (square), M2 (diamond), M3 (circle), and M4 (flag), and a sixteen-color palette as editing colors are provided by a manufacturer. As a result, each operator can edit the marking using the colors in the palette in the edit screen of the corresponding image server, even if an arrangement is made among the operators that the marking M1 is assigned to a live relay broadcast of baseball, the marking M2 to a live relay broadcast of soccer, the marking M3 to news shows, and the marking M4 to live relay broadcasts of marathons. This often causes a slight difference in the markings among the image servers.

As described above, due to the editing to the markings by the operators, it is difficult to determine the content of the piece of data based on the markings by the image server itself, even if there is an arrangement among the operators. Consequently, each operator who manipulates each image server is required to visually confirm the marking to determine the content of the piece of data. With the data management apparatus according to the present invention, it is possible to determine the content of the piece of data regardless of whether or not the marking has been edited based on functions that are described in detail below.

FIG. 6 is a functional configuration diagram of the data management apparatus 1 of the present embodiment. Referring to FIG. 6 in addition to FIG. 3, the data management apparatus 1 is provided with a specifying information obtaining unit 401, an identification information storing unit 402, a collating unit 403, and an assigning unit 404, by the components illustrated in FIG. 3 and a program working together. In the present embodiment, the specifying information obtaining unit 401 is configured by the hard disk controller 361 and the like, the identification information storing unit 402 is configured by the memory 381 and the like, and the collating unit 403 and the assigning unit 404 are configured by the CPU 371 and the like. By way of each of these means, the CPU 371 can realize: (1) a group assignment function of assigning a piece of specifying information to any one of the plurality of groups based on the piece of basic information included in the piece of specifying information, even if the marking and such added to the piece of data has been edited by an operator manipulating the image server; and (2) a unique information addition function of adding unique information such as an ID to the piece of data without overlapping. The following describes functions of the data management apparatus 1.

(1) Group Assignment Function

The CPU 371 has the identification information storing unit 402 previously store a plurality of pieces of identification information each of which is associated with one of a plurality of groups. Then, the CPU 371 has the specifying information obtaining unit 401 obtain a piece of specifying information that is assigned to a piece of data, and then has the collating unit 403 determine whether or not the piece of specifying information is matched with the plurality of pieces of identification information one by one. When the piece of specifying information is judged to be matched with one of the plurality of pieces of identification information by the collating unit 403, the CPU 371 has the assigning unit 404 assign the piece of data to the group with which the piece of identification information that has been judged to be matched is associated. Here, the piece of specifying information is generated to include a single piece of unmodifiable basic information that is associated with one of the plurality of groups. The CPU 371 has the assigning unit 404 assign the piece of data to the group with which the piece of basic information included in the piece of specifying information is associated.

By this, the data management apparatus 1 can adequately assign a piece of data to a group, even if a piece of specifying information such as a marking that is added to the piece of data has been edited by an independently managed server.

(2) Unique Information Addition Function

The identification information storing unit 402 stores a plurality of unique information that is associated with the plurality of groups on a one-to-one basis, and when the assigning unit 404 assigns the piece of data to one of the groups, the identification information storing unit 402 associates a piece of unique information that is associated with the group with the piece of data as the unique information of the piece of data and stores the piece of unique information. When the identification information storing unit 402 stores the piece of unique information that is associated with the group as the unique information of the piece of data, if a piece of unique information different from the piece of unique information of the group has already been stored in the identification information storing unit 402 as the unique information of the piece of data, the identification information storing unit 402 compares the piece of unique information of the group with the unique information of the piece of data that is already stored in the identification information storing unit 402, and replaces one of the pieces of unique information of the group and of the piece of data with the other according to a predetermined rule.

By this, the data management apparatus 1 can adequately assign an ID to a piece of data among servers, even if a piece of specifying information such as a marking that is added to the piece of data has been edited by an independently managed server. Furthermore, even if the piece of data has been already assigned with a different ID among the servers, it is possible to adjust the IDs that are overlapping according to the predetermined rule.

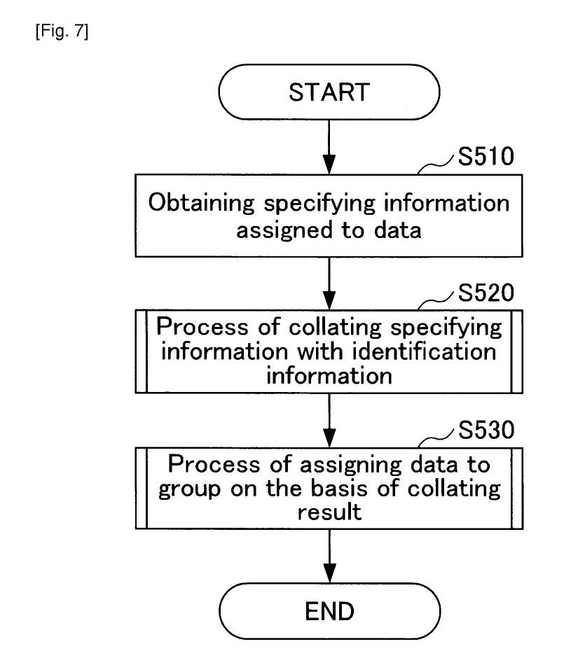

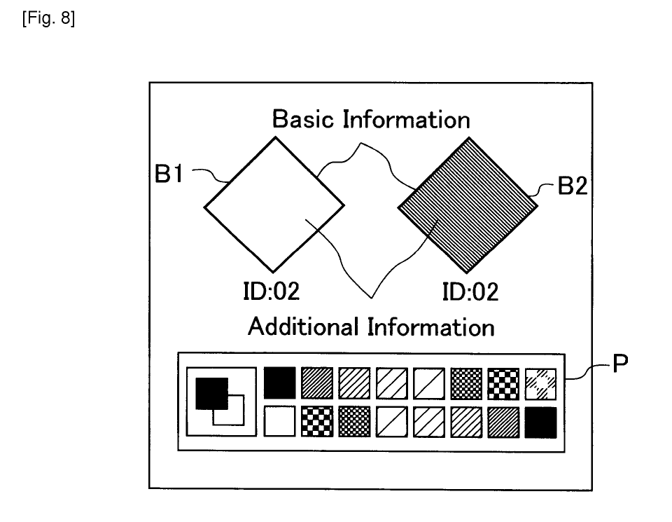

FIG. 7 is a flowchart showing one example of a data management method of one embodiment carried out by the data management apparatus 1 described with reference to FIG. 1 to FIG. 6. FIG. 8 and FIG. 9 are diagrams respectively illustrating the pieces of specifying information, the pieces of identification information, and the pieces of unique information. The data management method according to one embodiment of the present invention is described with reference to FIG. 7 to FIG. 9. The following description of the present embodiment also refers to FIG. 1 to FIG. 6 as needed.

Referring to FIG. 7, first, in Step S510, the CPU 371 has the specifying information obtaining unit 401 obtain a piece of specifying information assigned to a piece of data. More specifically, the CPU 371 controls the hard disk controller 361 so as to read the piece of data that has been received from a different server such as during the negotiation among the servers and stored in the hard disk drive 201, and to store the piece of specifying information assigned to the piece of data in the memory 381.

Here, the piece of specifying information to be obtained is information displayed as the marking A on the screen 10 of the display 210 that is explained with reference to FIG. 4.

In Step S520, the CPU 371 has the collating unit 403 carry out a collation process of collating the piece of specifying information assigned to the piece of data obtained in Step S510 with pieces of identification information stored in the memory 381 as the identification information storing unit 402 one by one.

In Step S530, the CPU 371 has the assigning unit 404 carry out an assignment process of assigning the piece of data to a group associated with the piece of identification information that has been judged to be matched with in Step S520.

As explained with reference to FIG. 5, the piece of specifying information assigned to the piece of data associated with the marking A may have been edited in its color and such by making a modification to marking information previously provided as M1, M2, M3, and M4 by the manufacturer using the sixteen color palette. FIG. 8 is a diagram illustrating a relationship between information (hereinafter referred to as “basic specifying information”) B1 associated with the markings provided by the manufacturer and information (hereinafter referred to as “modified specifying information”) B2 associated with the markings that may have been modified by the operator using the image server.

The basic specifying information B1 is known information as it is associated with commercially available markings, and it is easy to generate beforehand pieces of identification information corresponding thereto and store the pieces of identification information in the memory 381. In contrast, the modified specifying information B2 is associated with markings that may have been generated by modifying the commercially available markings by the operator using an individual server, and it generally has been difficult to generate all of the pieces of associated identification information.

In general, when editing the marking, the operator often changes the color of the marking using the palette, but rarely modifies the shape of the marking itself. The inventors of the present invention have noted this fact, and classify information constituting markings included in the specifying information into information representing a shape of a graphic symbol that is rarely edited (hereinafter referred to as “piece of basic information”) and information representing a color that is a target to be edited (hereinafter referred to as “piece of additional information”), and assign the piece of data to the group based on the piece of basic information representing the shape of the marking included in the piece of specifying information associated with the marking.

FIG. 9 is a table showing a relationship between the pieces of the specifying information and unique information IDs of the group to be assigned. Furthermore, the number of bytes indicating a data size shown in the table of FIG. 9 does not include a size of a header. In the present embodiment, the pieces of specifying information are roughly divided into groups based on information representing four types of markings including M1 (square), M2 (diamond), M3 (circle), and M4 (flag), and a piece of specifying information is assigned to one of the four types of markings including M1 (square), M2 (diamond), M3 (circle), and M4 (flag), and the piece of data is associated with the unique information ID of the corresponding group. Assuming that the commercially available markings are white markings of M1 (square), M2 (diamond), M3 (circle), and M4 (flag), it is possible to obtain the basic specifying information representing the white markings of M1 (square), M2 (diamond), M3 (circle), and M4 (flag). In contrast, as the operator of each server can change the colors of the commercially available markings from white to different colors using the sixteen color palette, it is assumed that the markings modified by the operator are markings of M1 (square), M2 (diamond), M3 (circle), and M4 (flag) in different colors. Accordingly, information representing the markings of M1 (square), M2 (diamond), M3 (circle), and M4 (flag) in red, yellow, blue, and so on changed from white can be expected as the modified specifying information. Therefore, as shown in FIG. 9, the specifying information is divided into the basic information that is rarely edited and the additional information that easily becomes a target to be edited, then the additional information representing the color such as white, red, yellow, blue, and such is excluded, and an ID as the unique information is associated with the piece of data based on the corresponding basic information representing the shape of M1 (square), M2 (diamond), M3 (circle), or M4 (flag).

As shown in FIG. 9, in an actual implementation, in order to facilitate the processing, the piece of basic information representing the shape of the marking is comprised of binary data of, for example, 16*16=256 bytes excluding the header, and the piece of additional information representing the color of the marking is comprised of binary data up to 768 bytes, for example. The piece of additional information representing the color of the marking can be 24 bits of a color depth*a number of colors. Therefore, if the number of colors is limited to sixteen, the size of the piece of additional information can be reduced down to 48 bytes. Furthermore, in the present embodiment, the size of the unique information ID assigned to the piece of specifying information is 16 bytes as a combination of 7-byte information corresponding to the shape and the color and 9-byte information mainly corresponding to the color. The piece of basic information stored in the memory 381 will be detailed later, but can be previously generated based on the commercially available white marking of M1 (square), M2 (diamond), M3 (circle), and M4 (flag), or can be generated as needed based on the marking A assigned to the piece of data that has already been stored in the hard disk controller 361. A detailed description is provided below.

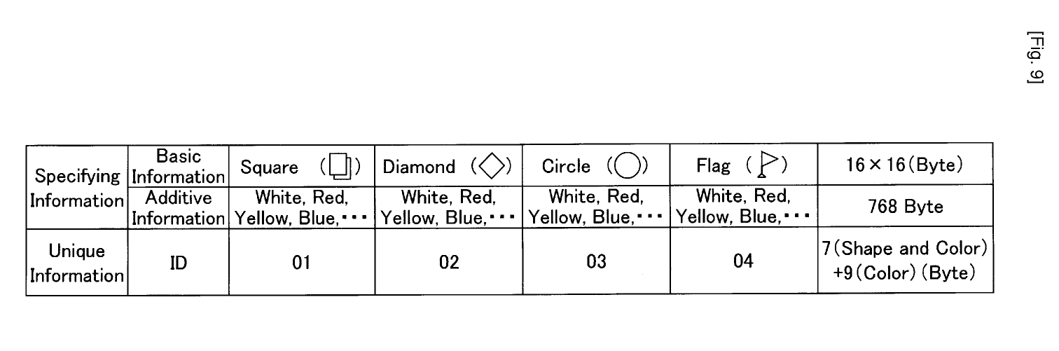

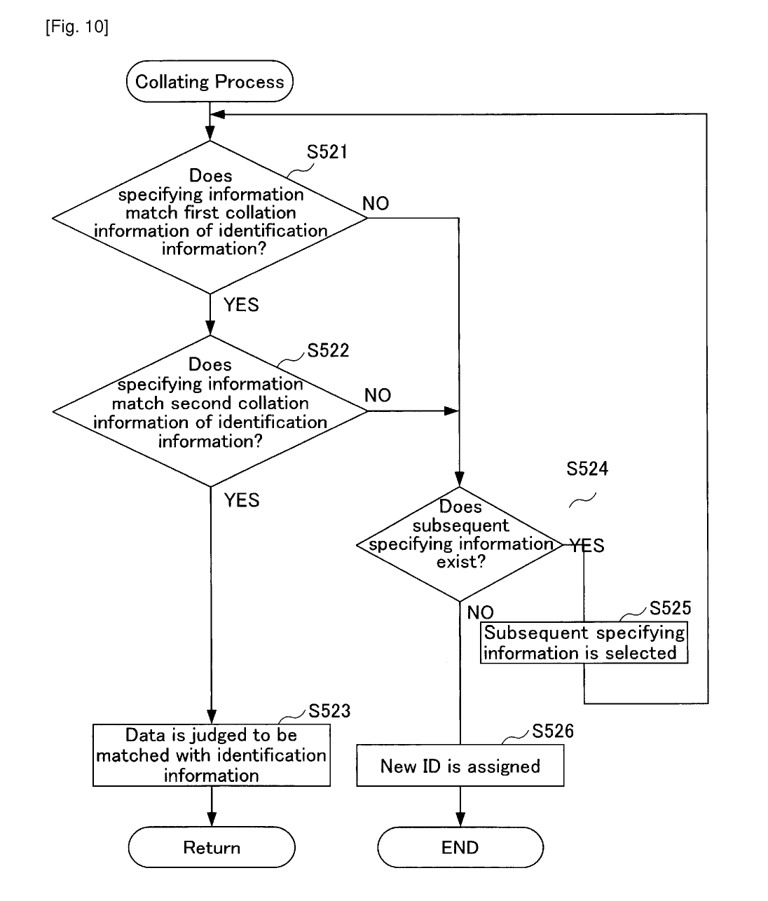

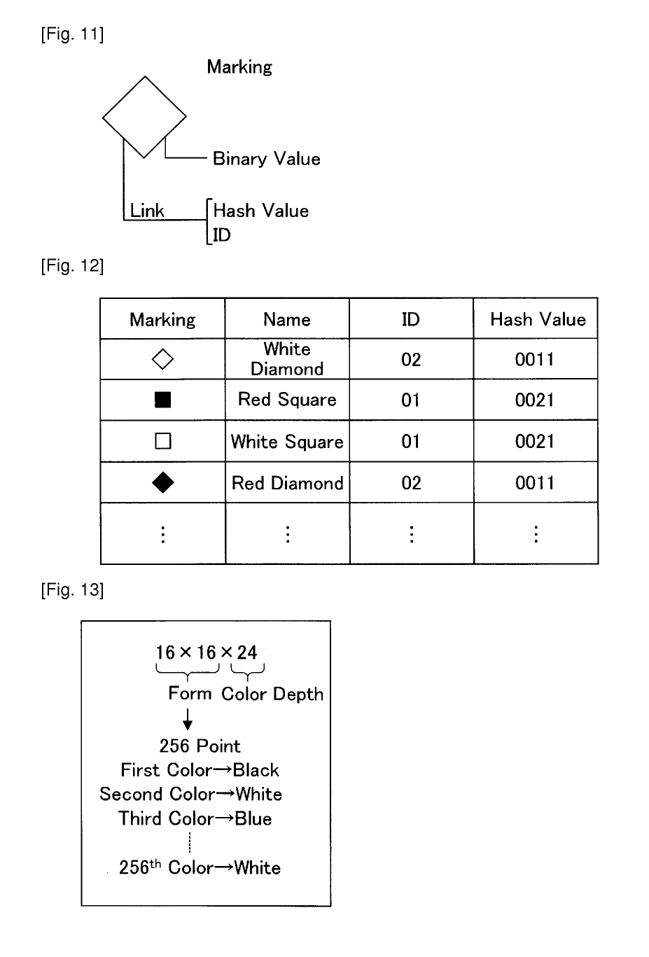

FIG. 10 is a flowchart illustrating one example of the collation process carried out in Step S520 described with reference to FIG. 7. FIG. 11 is a diagram schematically illustrating the marking assigned to the piece of data. FIG. 12 is a diagram showing a relationship between the marking, the unique information ID, and a hash value. FIG. 13 is a diagram showing one example of a method of generating the piece of identification information. One example of the collation process carried out in Step S520 is described below with reference to FIG. 10 to FIG. 13.

It is assumed that, when the CPU 371 collates the piece of specifying information extracted from the piece of data by the collating unit 403 with the piece of identification information stored in the memory 381, a binary comparison of each piece of information by the binary value can be conducted separately; however, this makes a cost too burdensome (i.e. it takes too long to process). Accordingly, the piece of specifying information and the piece of identification information can be respectively converted into information simpler than binary values and then compared, and when the pieces of information are determined to match, the comparison can be conducted by the binary value. In the present embodiment, the piece of specifying information and the piece of identification information are respectively converted into hash values and then compared, and when the pieces of information as the hash values are determined to match, the comparison by the binary value is conducted. Accordingly, it is necessary to generate the pieces of identification information associated not only with the piece of basic specifying information but also with the piece of modified specifying information expected from the piece of basic specifying information both in hash value and binary value, and store as first pieces of collating information and second pieces of collating information in the memory 381.

The marking is binary data of 768 bytes for the piece of additional information representing the color added with the header, and when reading the server such as in negotiation, and is reconstructed using a color table indicating corresponding position information, and binary data of 256 bytes is extracted as shape information. Therefore, the binary data of 256+768=1024 bytes is accumulated in the memory 381, as explained with reference to FIG. 9. In other words, the marking includes a binary value. Furthermore, as shown in FIG. 11, in addition to the marking including the binary values, a hash value and an ID generated from the binary data are linked to the marking. More specifically, as shown in FIG. 12, the hash value as well as the ID are associated with each marking and stored in the memory 381 according to a technique that will be later described in detail.

As already described, the marking is constituted by points specified by the piece of data (basic information) representing the shape of 16*16 bytes and a color specified by the piece of data (additional information) representing the color of 768 bytes (maximum). In the present embodiment, as the piece of identification information used for identifying the marking, the hash value and the binary value are used that are calculated by replacing the piece of data (additional information) representing a color at a corresponding point with the previously fixed color information, for each of 256 points specified by the piece of data (basic information) of 16*16 bytes in the piece of specifying information previously obtained and assigned to the piece of data or the piece of known basic specifying information, as shown in FIG. 13, with reference to the color table that represents the position information, in such a manner, for example, black for a first point, white for a second point, blue for a third point, . . . , and white for a 256th point. Each point can be expressed by 1 byte, as the replacement of the color information is carried out only by replacing the color information with the position information on the prescribed color table (for example, 256 colors). The hash value and the binary value of the marking thus calculated and removed with colors are stored in the memory 381 as the piece of identification information, along with the unique information IDs associated with the pieces of basic information on a one-to-one basis. The lower 9 bytes of the hash value and the binary value of marking removed with colors, i.e. the unique information ID associated with the piece of identification information, can be 0 so as to indicate, from the ID, whether or not the colors have been removed.

In the present embodiment, the unique information ID of the piece of identification information thus calculated and previously stored in the memory 381 by associating with the piece of basic information can be the unique information ID of the group. Furthermore, when collating the piece of specifying information and the piece of identification information of the marking assigned to the piece of data as a target, the collating unit 403 also calculates the hash value and the binary value by replacing the piece of data (additional information) representing a color with the previously fixed color information for each of the 256 points specified by the piece of data (basic information) of 16*16 bytes by the same rule, for example, black for the first point, white for the second point, blue for the third point, . . . , and white for the 256th point. In this manner, the pieces of specifying information having an identical piece of data (basic information) representing the shape are associated with the hash value and the binary value that are identical, regardless of the piece of data (additional information) representing the color.

In Step S521, the CPU 371 has the collating unit 403 collate the piece of specifying information assigned to the piece of data obtained in Step S510 and the first piece of collating information of one of the plurality of pieces of identification information stored in the memory 381. The collated piece of identification information can be selected, for example, in ascending order of the associated unique information IDs. In the present embodiment, the hash value calculated from the binary value of the marking assigned to the piece of data according to the above technique is collated with the hash value of the piece of identification information stored in the memory, and whether or not the values are matched is judged. When it is judged that the values are matched, the process advances to Step S522, and when it is judged that the values are not matched, the process advances to Step S524.

In Step S522, the CPU 371 collates the piece of specifying information with the second piece of collating information, stored in the memory 381, of the piece of identification information that has been judged to be matched with the first piece of collating information in Step S521, and judges whether or not the values are matched. In the present embodiment, the binary value of the marking assigned to the piece of data is collated with the binary value of the piece of identification information that has been judged to be matched in Step S521, and whether or not the values are matched is judged. When it is judged that the values match, the process advances to Step S523, and when it is judged that the values do not match, the process advances to Step S524.

In Step S523, the CPU 371 judges that the piece of data is matched with the piece of identification information that has been judged to match the second piece of collating information in Step S522.

In Step S524, the CPU 371 judges whether or not a next piece of identification information is present, that is, whether or not a piece of identification information that is not collated is present. More specifically, the CPU 371 can judge whether or not a piece of identification information associated with a unique information ID that is greater than the unique information ID of the piece of identification information that has been collated in the immediately previous step is present among the plurality of pieces of identification information stored in the memory 381, for example. When it is judged to be present in Step S524, the process returns to Step S521, and repeats Step S521 and Step S522 until the piece of identification information that is judged to be matched with the piece of specifying information of the piece of data is found (YES in Step S522), or until it is judged that a piece of identification information to be collated is not present (NO in Step S524).

In Step S526, the CPU 371 determines that no unique information ID is presently associated with the piece of specifying information of the piece of data, and assigns a new unique information ID. The newly assigned ID is generated according to a predetermined rule. In the present embodiment, as shown in FIG. 9, the newly assigned ID is generated using a random number so as to be constituted by the shape and the color of 16 bytes as a combination of 7 bytes mainly corresponding to the shape and 9 bytes mainly corresponding to the color.

As described above, in the present embodiment, the piece of specifying information and the piece of identification information are compared by the hash values as the simple information, and by the binary values as more complex information. Only the piece of identification information that is judged to be matched by the hash value is collated using the precise information, i.e. by the level of the binary values. Then, when it is judged to be matched by the binary value, the piece of data is associated to the group associated with the piece of identification information. As a result, a cost and time involved in the comparison and collation can be reduced to a large extent.

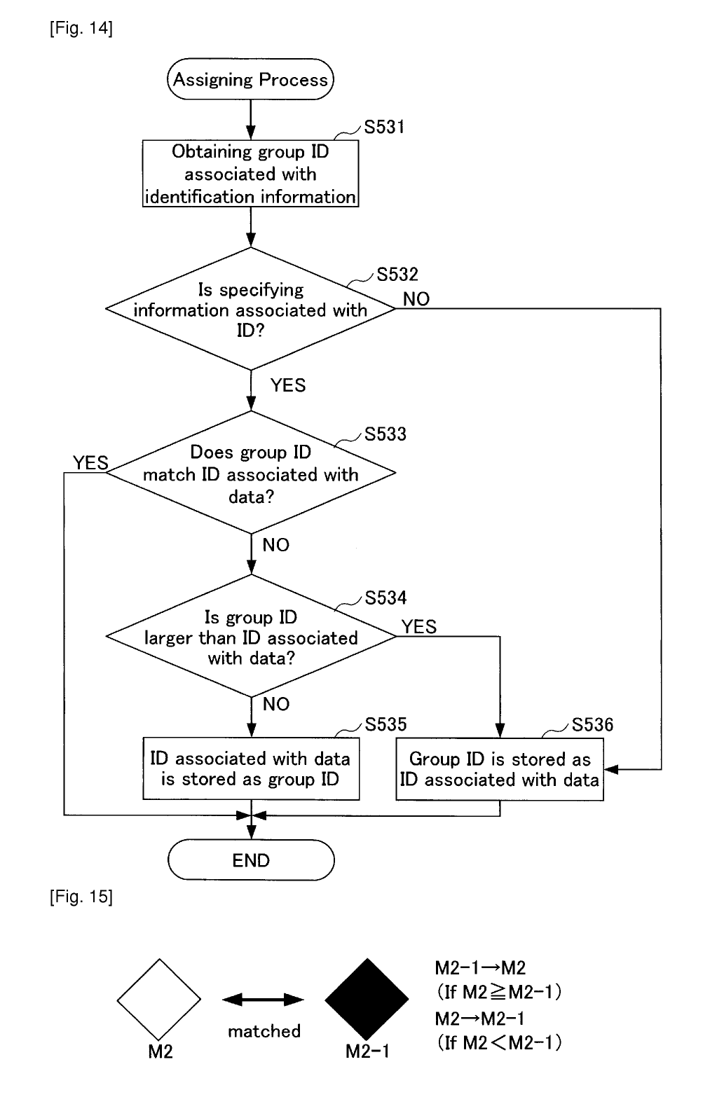

FIG. 14 is a flowchart illustrating one example of the assignment process carried out in Step S530 described with reference to FIG. 7. FIG. 15 is a diagram illustrating details of the assignment process of the unique information IDs without overlapping. One example of the assignment process carried out in Step S530 is described in detail with reference to FIG. 14 and FIG. 15. The following process can be carried out regularly by each server. Alternatively, the following process can be carried out separately by each server in the background when a new server is connected to the network, as a process for registering the piece of specifying information along with the unique information ID, or of associating the piece of data with the ID of the piece of specifying information without overlapping.

First, in Step S531, the CPU 371 obtains the unique information ID, more particularly, the upper 7 bytes of the unique information ID that mainly represents the shape, of the group associated with the piece of identification information that has been judged to be matched in Step S520. For example, as shown at the bottom right of FIG. 2, the unique information IDs associated with the groups (i.e. the shape of the marking represented by the identification information) are stored in the memory 381, in such a manner that 01 for the group associated with the piece of identification information M1 (square), 02 for M2 (diamond), 03 for M3 (circle), and 04 for M4 (flag). Then, the unique information ID of the group associated with the piece of identification information that has been judged to be matched in Step S520, for example, 01 for M1 (square), 02 for M2 (diamond), 03 for M3 (circle), 04 for M4 (flag), is obtained from the memory 381. Alternatively, in the present embodiment, the unique information ID of the piece of identification information that has been previously calculated, associated with the piece of basic information, and previously stored in the memory 381, can be the unique information ID of the group. More specifically, for example, as shown at the bottom right of FIG. 2, the unique information IDs associated with the group can be stored in the memory 381 as the unique information ID of the piece of identification information such that the group associated with the piece of identification information (i.e. the shape of the marking represented by the identification information) is 01 for M1 (square), 02 for M2 (diamond), 03 for M3 (circle), and 04 for M4 (flag). Then, the unique information ID of the piece of identification information that has been judged to be matched in Step S520, for example, 01 for M1 (square), 02 for M2 (diamond), 03 for M3 (circle), 04 for M4 (flag) can be obtained from the memory 381.

In Step S532, the CPU 371 judges whether or not the piece of specifying information has already been assigned with a unique information ID. More specifically, the CPU 371 judges whether or not the piece of specifying information is stored in the memory 381 with a unique information ID already associated therewith. When it is judged to be associated, the process advances to Step S533, and when it is judged to be not associated, the process advances to Step S536.

In Step S533, the CPU 371 judges whether or not the unique information ID of the group, i.e. the group ID, is matched with the unique information ID that has already been associated with the piece of specifying information. When it is judged not to be matched, the process advances to Step S534.

In Step S534, the CPU 371 judges whether or not the unique information ID of the group is greater than the unique information ID that has already been associated with the piece of data. For example, as shown in detail in FIG. 15, when a targeted marking is a red diamond, and a unique information ID has already been associated as M2−1, the CPU 371 judges whether or not M2 as the unique information ID of the group is greater than M2−1 as the unique information ID. In a case where it is judged to be greater, the process advances to Step S536, and in a case where it is judged not to be greater, the process advances to Step S535.

In Step S535, the CPU 371 stores the unique information ID associated with the piece of data in the memory 381 as the unique information ID of the group. More specifically, the unique information ID of the group for the diamond is updated to M2−1 from M2, and the unique information ID of the piece of data remains M2−1. In the present embodiment, all of the unique information IDs of the pieces of identification information having the same basic information stored in the memory 381 are updated to M2−1.

In Step S536, the CPU 371 associates the unique information ID of the group with the piece of data and stores in the memory 381 as ID. That is, M2 is stored as the unique information ID of the piece of data.

The unique information that is stored with association when registering the piece of specifying information, i.e. the ID, can be automatically assigned by the server as described above, or a Universally Unique Identifier (hereinafter referred to as “UUID”) can be used. The UUID is 128-bit data, with which two identical IDs are considered to hardly occur (see RFC (Request for Comments) 4122 of IETF (Internet Engineering Task Force) and such for more detail).

In the present embodiment, first, the hash values are compared, and if the hash values are identical, the binary values are compared, and then, if the binary values are judged to be identical, the IDs are compared. Then, if necessary, one with a greater value, for example, is selected according to a consistent rule, and the piece of data stored in the server thereof is updated as needed in addition to assigning of a new ID to the piece of data. With this, it is possible to register the IDs without overlapping and without a server of an upper level that manages negotiation among the servers.

While the technique according to which the upper 7 bytes of the unique information ID mainly representing the shape are assigned to the markings without overlapping is explained, the markings judged to have the same shape information, that is, the markings whose upper 7 bytes of the unique information IDs are identical, can be further assigned with the lower 9 bytes of the unique information IDs representing the color using a similar technique. For example, the second piece of identification information is created focusing a part of the color information at a position that is considered to be rarely modified, and the aforementioned collation and grouping are carried out using the second piece of identification information while a majority of the color information of the marking is replaced, but the limited part of the color information that is considered to be rarely modified is not replaced, thereby assigning the IDs without overlapping. With this, it is possible to further classify the pieces of data into groups smaller than the categories such as live relay broadcasts of baseball, live relay broadcasts of soccer, and news shows.

Furthermore, in the data management apparatus according to the present invention, even if the piece of specifying information is generated by adding the piece of additional information as the modification target to the piece of basic information, the plurality of pieces of identification information is generated by adding the piece of additional information, according to a predetermined technique, to one of the plurality of pieces of unmodifiable basic information that correspond to the plurality of groups on a one-to-one basis, and the collating unit collates the piece of specifying information and the plurality of pieces of identification information to judge whether or not the pieces of information match, after modifying the piece of specifying information so as to make the piece of additional information included in the piece of specifying information in the same condition as the pieces of additional information included in each of the plurality of pieces of identification information according to the predetermined technique. Therefore, no matter what kind of modification is made to a piece of specifying information such as a marking added to the data such as by an independently managed server, the piece of specifying information is collated with the pieces of identification information to judge whether or not the pieces of information match, after modifying a portion corresponding to the piece of additional information included in the piece of specifying information so as to be in the same condition as a portion corresponding to the pieces of additional information included among the plurality of pieces of identification information. Therefore, it is possible to adequately assign the piece of data to the group to which the piece of data can belong based on the piece of basic information. With this, a cost and time involved in the comparison or collation can be further reduced.

Furthermore, the data management apparatus according to the present invention can be such that the identification information storing unit stores a plurality of pieces of unique information that are associated with the plurality of groups on a one-to-one basis, and when the assigning unit assigns the piece of data to one of the groups, the identification information storing unit stores the piece of unique information associated with the one group as the unique information of the piece of data. Accordingly, the data management apparatus according to the present invention can automatically negotiate among servers, especially when a new server is connected to a network, and register pieces of unique information that are associated with the data, for example, IDs, as needed.

In addition, the data management apparatus according to the present invention can be such that, when the identification information storing unit stores the piece of unique information associated with the one group, for example, an ID, as the unique information of the piece of data, if a piece of unique information different from the piece of unique information associated with the one group is already stored in the identification information storing unit as the unique information of the piece of data, the identification information storing unit compares the piece of unique information associated with the one group with the unique information of the piece of data that is already stored in the identification information storing unit, and replaces one of the pieces of unique information associated with the one group and the unique information of the piece of data with the other according to a predetermined rule. Accordingly, even when different IDs have already been assigned to the data among the servers, and even when there is a possibility that an overlapping ID can be assigned, it is possible to adjust according to the predetermined rule.

While a specific embodiment of the present invention has been described in the above, the present invention is not limited to the present embodiment above. Furthermore, the effects of the present invention described in the embodiment are merely listed as most preferred effects realized by the present invention, and effects of the present invention are not limited to those described in the examples of the present invention.

For example, in the above embodiment, the ID of a greater value is selected according to the consistent rule. However, the present invention is not limited to such an example, and any rule can be employed as long as the unique information such as IDs can be registered without overlapping.

For example, in the above embodiment, while the first piece of collating information is the hash value of the piece of identification information, and the second piece of collating information is the binary value of the piece of identification information, the present invention is not limited to such an example. The first piece of collating information and the second piece of collating information can be any values other than the binary values or hash values, as long as the second piece of collating information is more precise than the first piece of collating information and it is considered to be suitable considering an application and an amount of the managed data.

In the above embodiment, the piece of basic information is explained as the piece of data representing the shape, and the piece of additional information is explained as the piece of data representing the color. However, the present invention is not limited to such an example. The basic information can be any information as long as it represents a portion of the specifying information that is not significantly modified, and the additional information can be determined according to an implementation as long as it is included in the specifying information. Furthermore, while the piece of specifying information is explained as the marking or the graphic symbol, the present invention is not limited to such an example. As long as the information includes basic information that is not modified very often, even if a user edits the information as a portion of the specifying information, other information such as values, portions of audio data, or such can be used as the specifying information, in addition to the markings and the graphic symbols.

From the foregoing description, it is to be understood that the data management apparatus according to the present invention can automatically and adequately generate an ID with which the identity of pieces of data can be verified and associate the ID with the pieces of data, even if specifying information such as a marking assigned to the piece of data has been edited by a completely independent server. Accordingly, it is possible to efficiently manage various data that is transmitted and received via a network or the like.

### REFERENCE SIGNS LIST

1 to 4 data management apparatus
10 screen
100 to 400 image server
102 controller
135 system monitor
210 display
315 transmitting and receiving unit
361 hard disk controller
362 hard disk drive
371 CPU
381 memory
401 specifying information obtaining unit
402 identification information storing unit
403 collating unit
404 assigning unit

1. A data management apparatus that manages data transmitted and received between computers, the data management apparatus comprising:
a specifying information obtaining unit that obtains a piece of specifying information assigned to a piece of data;
an identification information storing unit to store a plurality of pieces of identification information that are associated with a plurality of groups, respectively;
a collating unit to collate the piece of specifying information and the plurality of pieces of identification information, and specify a corresponding one of the pieces of identification information; and
an assigning unit to assign the piece of data to a group associated with the piece of identification information specified by the collating unit, wherein the piece of specifying information and the plurality of pieces of identification information are generated to respectively include pieces of unmodifiable basic information that correspond to the plurality of groups, and
wherein the collating unit specifies the corresponding piece of identification information based on the basic information included in the piece of specifying information.

2. The data management apparatus as set forth in claim 1, wherein the piece of specifying information is generated by adding a piece of additional information as a modification target to the piece of basic information.

3. The data management apparatus as set forth in claim 2, wherein the plurality of pieces of identification information is generated by adding the piece of additional information, according to a predetermined technique, to one of the plurality of pieces of unmodifiable basic information that correspond to the plurality of groups on a one-to-one basis,
and said collating unit collates the piece of specifying information and the plurality of pieces of identification information to judge whether or not the pieces of information match, after modifying the piece of specifying information so as to make the piece of additional information included in the piece of specifying information in the same condition as the pieces of additional information included in each of the plurality of pieces of identification information according to the predetermined technique.

4. The data management apparatus as set forth in claim 2, wherein the piece of specifying information is information representative of a graphic symbol.

5. The data management apparatus as set forth in claim 2, wherein the pieces of basic information is information each representative of a shape of a graphic symbol, and the piece of additional information is information representative of a color of the graphic symbol.

6. The data management apparatus as set forth in claim 1, wherein each of the plurality of pieces of identification information includes a first piece of collating information and a second piece of collating information, said collating unit collates the piece of specifying information and the first piece of collating information included in each of the plurality of pieces of identification information, when it is judged that the piece of specifying information is matched with the first piece of collating information of one of the plurality of pieces of identification information, the piece of specifying information is collated with the second piece of collating information of the one piece of identification information that has been judged to be matched with the piece of specifying information, and when it is determined that the piece of specifying information is matched with the second piece of collating information of the one piece of identification information, said assigning unit assigns the piece of data to one of the groups that is associated with the one piece of identification information.

7. The data management apparatus as set forth in claim 6, wherein the plurality of first pieces of collating information include hash values of the plurality of pieces of identification information.

8. The data management apparatus as set forth in claim 6, wherein the plurality of second pieces of collating information include binary values of the plurality of pieces of identification information.

9. The data management apparatus as set forth in claim 1, wherein the identification information storing unit stores a plurality of pieces of unique information that are associated with the plurality of groups on a one-to-one basis, and
when said assigning unit assigns the piece of data to one of the groups, said identification information storing unit stores the piece of unique information associated with the one group as the unique information of the piece of data.

10. The data management apparatus as set forth in claim 9, wherein when the identification information storing unit stores the piece of unique information associated with the one group as the unique information of the piece of data, if a piece of unique information different from the piece of unique information associated with the one group is already stored in said identification information storing unit as the unique information of the piece of data, said identification information storing unit compares the piece of unique information associated with the one group with the unique information of the piece of data that is already stored in said identification information storing unit, and replaces one of the pieces of unique information associated with the one group and the unique information of the piece of data with the other according to a predetermined rule.

11. A data management method that manages data transmitted and received between computers, the data management method comprising:
a specifying information obtaining step of obtaining a piece of specifying information assigned to a piece of data;
an identification information storing step of storing a plurality of pieces of identification information that are associated with a plurality of groups, respectively;
a collating step of collating the piece of specifying information and the plurality of pieces of identification information, and specifying a corresponding one of the pieces of identification information; and
an assigning step of assigning the piece of data to a group associated with the piece of identification information specified in the collating step,
wherein the piece of specifying information and the plurality of pieces of identification information are generated to respectively include pieces of unmodifiable basic information that correspond to the plurality of groups, and
wherein said collating step includes a step of specifying the corresponding piece of identification information based on the basic information included in the piece of specifying information.

12. A data management program for managing data transmitted and received between computers, the data management program being executable by a computer to carry out, the program comprising:
a specifying information obtaining step of obtaining a piece of specifying information assigned to a piece of data;
an identification information storing step of storing a plurality of pieces of identification information that are associated with a plurality of groups, respectively;
a collating step of collating the piece of specifying information and the plurality of pieces of identification information, and specifying a corresponding one of the pieces of identification information; and
an assigning step of assigning the piece of data to a group associated with the piece of identification information specified in the collating step,
wherein the piece of specifying information and the plurality of pieces of identification information are generated to respectively include pieces of unmodifiable basic information that correspond to the plurality of groups, and
wherein said collating step includes a step of specifying the corresponding piece of identification information based on the basic information included in the piece of specifying information.
